(19) United States
(12) Patent Application Publication
(10) Pub. No.: US 2024/0165786 A1
(43) Pub. Date: May 23, 2024

(54) SYSTEM HAVING A GUIDE RAIL AND A CARRYING DEVICE

(71) Applicant: FESTOOL GMBH, Wendlingen (DE)

(72) Inventor: Markus WILDERMUTH, Denkendorf (DE)

(21) Appl. No.: 18/284,348

(22) PCT Filed: Mar. 31, 2022
(86) PCT No.: PCT/EP2022/058596

§ 371 Date: Sep. 27, 2023

(30) Foreign Application Priority Data
Apr. 1, 2021 (DE) 20 2021 101 782.1

(51) Int. Cl. B25H 1/00

(52) U.S. Cl. CPC B25H 1/0078

(57) ABSTRACT

A system including at least one guide rail (21, 22) which is provided for guiding a hand-held power tool (11), has an elongate shape and extends along a longitudinal axis, wherein the guide rail (21, 22) has, on mutually opposite sides, a contact face (24) for the guide rail (21, 22) to rest on a workpiece (W), and has a guide face (23), in front of which a longitudinal guide face (31), extending along the respective longitudinal axis (L1, L2), for guiding the hand-held power tool (11) protrudes parallel to the longitudinal axis (L1, L2). The system includes a carrying device (200) having a carrying body (201, 202) and a carrying handle (120), arranged on the carrying body (201, 202), to be grasped by an operator (BE), wherein the guide rail (21, 22) has, for connecting to the carrying device (200), form-fitting contours (34) which are able to be brought into engagement with mating form-fitting contours (124) of the carrying device (200) such that the guide rail (21, 22) is able to be carried by a user (BE) using the carrying handle (120).

The invention relates to a system comprising at least one guide rail which is provided for guiding a hand-held power tool, has an elongate shape and extends along a longitudinal axis, wherein the guide rail has, on mutually opposite sides, a contact face for the guide rail to rest on a workpiece and a guide face in front of which a longitudinal guide face extending along the respective longitudinal axis for guiding the hand-held power tool protrudes parallel to the longitudinal axis.

As a rule such a guide rail has an elongate rail body which, although having the desired guide properties for the hand-held power tool, is unwieldy and difficult to transport.

A guide rail for a hand-held power tool is described in DE 10 2010 028 751 A1.

A container with a flexible guide rail emerges from DE 202 18 480 A1.

A portable container with a working plate emerges from DE 10 2013 008 630 A1 or from DE 10 2017 109 023 A1. U.S. Pat. No. 11,008,136 B2 describes a stack of portable containers.

The present invention is therefore based on the problem of improving the carrying comfort when carrying such a guide rail.

To solve this problem, it is provided in a system of the type mentioned at the beginning that it comprises a carrying device having a carrying body and a carrying handle located on the carrying body to be grasped by an operator, wherein the guide rail, for a connection to the carrying device, has form-fitting contours which can be brought into engagement with mating form-fitting contours of the carrying device, so that the guide rail can be carried by an operator using the carrying handle.

Using the carrying handle, the guide rail can be gripped comfortably. The form-fitting contours for example comprise at least one locating groove, in particular a locating groove at a guide projection having the longitudinal guide face. One or more hooks can be brought into engagement with the locating groove, acting as mating form-fitting contours of the carrying device.

The carrying handle is for example designed in the manner of a handhold or carrying leg or carrying handhold.

Also provided are a guide rail and a carrying device, which are defined as follows:

Carrying device for carrying a guide rail provided for guiding a hand-held power tool, wherein the carrying device has a carrying body and a carrying handle located on the carrying body to be grasped by an operator, having mating form-fitting contours for engagement with form-fitting contours of the guide rail, so that the guide rail can be carried by an operator using the carrying handle.

Guide rail which can be carried by a carrying device, wherein the guide rail has an elongate shape and extends along a longitudinal axis, wherein the guide rail has, on mutually opposite sides, a contact face for the guide rail to rest on a workpiece and a guide face in front of which a longitudinal guide face extending along the respective longitudinal axis for guiding the hand-held power tool protrudes parallel to the longitudinal axis, wherein the guide rail, for a connection to the carrying device, has form-fitting contours which can be brought into engagement with mating form-fitting contours of the carrying device, and wherein the carrying device has a carrying body and a carrying handle located on the carrying body to be grasped by an operator, so that the guide rail can be carried by an operator using the carrying handle.

It is for example advantageous if the carrying device has a support face for the planar support of the guide rail, in particular the contact face or the guide face of the guide rail. The contact face or the guide face of the guide rail is preferably supported on the support face. Several support faces of the carrying device may be provided. It is preferred if a support face or a portion of a support face is provided on each of the opposite sides of the carrying handle. The carrying handle is advantageously located between edge regions of the support face.

It is particularly advantageous if the carrying handle projects in front of the support face when the carrying device and the guide rail are connected to each other by means of the form-fitting contours and the mating form-fitting contours.

It is for example advantageous if the guide rail has a through-opening for the carrying handle, which through-opening extends between two mutually opposite sides, in particular between the guide face and the contact face, and through which the carrying handle can be inserted. A supporting surface, in particular the above-mentioned support face, of the carrying body, is advantageously located adjacent to the carrying handle, where the guide rail is supported and/or which is provided for supporting the guide rail when the carrying handle is inserted through the through-opening. The guide rail is advantageously supported or supportable on the supporting surface or support face. The carrying handle projects at an angle, in particular a right angle, in front of the supporting surface or support face or at an angle from the supporting surface or support face. The supporting surface or support face of the carrying body is for example supported on the guide rail on the side averted from the carrying handle. The carrying handle can for example be inserted or pushed through from the guide face to the contact face or vice versa or transversely to the contact face or guide face. It is also possible, however, that the through-opening is laterally open, so that the carrying handle can be inserted into the through-opening in a direction parallel to the guide face and contact face or with a directional component which is parallel to the guide face or contact face.

The through-opening preferably has an elongate shape or is designed as a longitudinal slot. A longitudinal extent or longitudinal axis of the through-opening preferably extends parallel to the longitudinal axis of the guide rail.

It is possible that there is a distance between that section of the carrying device which carries the carrying handle and the supporting surface or support face provided for supporting the guide rail, for example if there is an indentation between the supporting surface or support face and the carrying handle. The supporting surface or support face can comprise plane surfaces or plane surface portions. It is also possible, however, that the supporting surface or support face provides a linear and/or point support of the guide rail.

It is readily possible that several supporting surfaces and/or support faces are provided on the carrying device for supporting the guide rail.

On the supporting surface or support face of the carrying device, a receptacle or indentation for the carrying handle can be provided, into which the carrying handle can be moved, for example pivoted, in an inoperative position and from which the carrying handle can be moved, for example pivoted, into an operative position for carrying the carrying device.

The through-opening preferably has an elongate shape. The through-opening preferably extends parallel or at a flat angle of less than 15° to a longitudinal axis of the guide rail.

The through-opening can be designed such that the carrying handle can be pushed through the through-opening in an inoperative position in which it is moved towards the carrying body.

The through-opening can have an inoperative position receptacle for the carrying handle, in which the carrying handle can be accommodated in an inoperative position moved towards the carrying body and/or the guide rail, in which inoperative position the carrying handle does not protrude in front of the guide rail in a position suitable for carrying the guide rail. The carrying handle is for example mounted on the carrying body for pivoting between the inoperative position and an operative position provided for carrying and can be accommodated in the inoperative position receptacle in the inoperative position.

An advantageous measure provides that the carrying handle protrudes in front of the guide face or the contact face, in particular at right angles, when the carrying device is connected to the guide rail.

The carrying handle can be arranged to be stationary on the carrying body, being thus immovable with respect to the carrying body. The carrying handle can for example extend at an angle, in particular a right angle, from the carrying body.

It is preferably provided, however, that the carrying handle is mounted on the carrying body for pivoting between an operative position, in which the carrying handle protrudes in front of the carrying body, and an inoperative position, in which the carrying handle is moved closer towards the carrying body than in the operative position. If not in use, the carrying handle can thus be moved towards the carrying body, for example.

A carrying handle capable of such adjustment can be fixed by mounting the guide rail on the carrying device. It is preferably provided that the carrying handle is fixed by the guide rail in the operative position when the guide rail and the carrying device are connected to each other. The guide rail forms a tilt protection device, for example. The carrying handle then for example bears, if the guide rail is connected to the carrying device by means of mutually engaging form-fitting contours, against one of the form-fitting contours of the guide rail or another support contour of the guide rail. The carrying handle is in particular held in the operative position at a through-opening or by a through-opening of the guide rail, through which the carrying handle is or can be inserted.

As explained above, an indentation or receptacle can be provided for the carrying handle, in which the carrying handle is accommodated in the inoperative position. It is preferred if the carrying handle does not project in the inoperative position in front of the supporting surfaces or support faces provided for supporting the guide rail. The guide rail is or can be supported on the supporting surfaces or support faces when the carrying handle is inserted through the through-opening of the guide rail.

An advantageous measure provides that the through-opening is located approximately in the longitudinal centre with respect to the longitudinal axis of the guide rail and/or approximately in the transverse centre between longitudinal sides of the guide rail extending parallel to the longitudinal axis of the guide rail. An advantageous measure therefore provides that the carrying handle is located approximately in the longitudinal centre with respect to the longitudinal axis of the guide rail and/or approximately in the transverse centre between longitudinal sides of the guide rail extending parallel to the longitudinal axis of the guide rail when the guide rail and the carrying device are connected to each other. The guide rail is thus optimally balanced and can be carried easily. There may also be situations, however, in which such a central orientation of the guide rail is not desirable, for example if a greater distance from the person carrying the combination of carrying device and guide rail is desired.

It is furthermore advantageous if the through opening and/or the carrying handle, when the guide rail and the carrying device are connected to each other, are/is located in the centre or close to the centre of the contact face and/or the guide face of the guide rail. For this it is for example provided that the carrying handle or the through-opening is located approximately in the longitudinal centre with respect to the longitudinal axis of the guide rail and/or approximately in the transverse centre between longitudinal sides of the guide rail extending parallel to the longitudinal axis of the guide rail. The centre is the geometrical centre or the centre of gravity of the guide rail.

It is furthermore advantageous if the guide rail does not protrude in front of the carrying device transversely to its longitudinal axis when the guide rail is located on the carrying device and/or if the carrying handle is inserted through the through-opening of the guide rail.

It is also advantageous if the guide rail is completely supported by the carrying device transversely to its longitudinal axis when the guide rail is located at the carrying device and/or when the carrying handle is inserted through the through-opening of the guide rail.

A transverse width of the supporting surface or support face of the carrying device, when the guide rail is located aon the carrying device, preferably corresponds at least to the transverse width of the guide rail transversely to the longitudinal axis of the guide rail, particularly of that section of the guide rail which is provided and/or designed to support the carrying device.

It is expedient if the carrying handle protrudes approximately at a right angle in front of the contact face and/or the guide face of the guide rail when the guide rail is connected to the carrying device. The carrying handle thus for example protrudes in front of large flat sides of the guide rail so as to be easily grasped.

It is advantageously provided that there is a reach-through opening provided and designed for grasping the handle portion with a hand of an operator between a handle portion of the carrying handle and the guide rail when the carrying handle is inserted through the through-opening and/or the guide rail is connected to the carrying device. A distance between the guide rail held on the carrying device and a handle portion of the carrying handle provided for grasping with the hand of the operator is at least 2 cm, further preferred 3 cm, preferably 4 cm, for example. A minimum width of the reach-through opening is preferably at least the width of a hand, preferably the width of two hands, of an adult operator, i.e. preferably at least 8 cm, in particular at least 10 cm.

It is furthermore advantageous if the carrying handle protrudes at approximately right angles in front of a support face of the carrying body at least in its operative position. The carrying handle can be fixed and/or immovable with respect to the carrying body, i.e. for example extending from the carrying body in a static fashion and/or permanently and/or at right angles in its operative position.

The guide rail can also be provided and designed for fixing the carrying handle non-pivotably. It is preferably provided that the carrying device and the guide rail can be connected to each other by means of the form-fitting contours and the mating form-fitting contours in such a way that the carrying handle cannot be pivoted and/or displaced with respect to the guide face when the carrying device and the guide rail are connected to each other. The non-pivotability or non-displaceability can obviously be such that a certain amount of motoric play, in particular the motoric play required for releasing the connection between carrying device and guide rail, is still possible.

It is advantageously provided that the carrying handle is, in particular exclusively, insertable through the through-opening along an insertion axis extending at an angle, in particular at an approximately or fully right angle, to the longitudinal axis of the guide rail.

It is also advantageous if the guide rail, when the carrying handle is inserted through the through-opening, is supported on the carrying device in a non-pivotable or substantially non-pivotable manner. To ensure non-pivotability, it can be provided that only a motoric play required for inserting the carrying handle through the through-opening is present between the through-opening and the carrying handle. The motoric play can be generously dimensioned, but is advantageously such that, although the carrying handle can be inserted through the through-opening along the insertion axis, the guide rail and the carrying handle cannot be pivoted relative to each other in such a way that they can be brought out of or into engagement with each other by a pivoting movement about a pivoting axis extending transversely to the insertion axis. This measure therefore ensures that the guide rail is securely supported against tilting relative to the carrying device.

The form-fitting contours and the mating form-fitting contours for example comprise is insertion guide faces extending parallel to the insertion axis. The form-fitting contours of the guide rail for example comprise insertion guide faces which are perpendicular to the guide face and/or to the contact face of the guide rail at the inner circumference of the through-opening for supporting and/or guiding insertion guide faces of the mating form-fitting contours provided at the carrying handle. The insertion guide faces of the mating form-fitting contours are for example provided on connecting portions or bearing portions of the carrying handle with which the carrying handle can be connected to the cover or a side wall of the transport container.

The carrying handle preferably has support contours extending parallel to a longitudinal extent of the through-opening, in particular plane surfaces, e.g. plane surfaces at the connecting portions or bearing portions of the carrying handle, acting as mating form-fitting contours on which form-fitting contours of the guide rail, for example longitudinal side walls of the through-opening extending parallel to the longitudinal extent of the through-opening, are or can be supported in a planar fashion.

It is furthermore advantageous if the carrying device and/or the guide rail have/has at least one latching contour for latching to the guide rail. In this way the form-fitting connection between carrying device and guide rail is additionally secured by latching.

The latching contour can be provided at the guide rail or the carrying device. The latching contour comprises a latching projection, a latching spring or the like, for example.

It is preferred if the at least one latching contour is located at the carrying handle and/or the through-opening and latches the carrying handle to the guide rail when the carrying handle is pushed or inserted through the through-opening. The latching contour is for example located at a side face or side wall of the carrying handle and can initially be moved into a release position when the carrying handle is pushed or inserted through the through-opening of the guide rail and then automatically adopt a latching position in which the latching contour latches to the guide rail.

The carrying body can be or have a carrying plate or the like, for example. The carrying body can exclusively be provided for supporting the guide rail. The carrying handle can for example be pivotably mounted on such a carrying plate or project from a carrying plate and be insertable through the through-opening of the guide rail.

The carrying plate can for example be designed in the manner of a cover of the transport is container described below.

It is preferred if the carrying body comprises a transport container with a location space for objects, in particular the hand-held power tool, or is represented by a transport container, the carrying handle being provided and designed for carrying the transport container. The location space is for example provided in a carcass of the transport container.

Although it is possible in principle for the carrying handle to be located at any point of the transport container, for example at a side wall, it is preferred if the carrying handle is located on a top side, in particular a cover, of the transport container. From the top side a storage space or location space of the transport container is accessible, for example.

The carrying handle protrudes in front of the top side of the transport container, for example, and extends through the through-opening of the guide rail. The guide rail can be supported on the top side of the transport container in a planar fashion.

It is for example preferred that the support face for supporting the guide rail is located on a top side, in particular a cover, of the transport container or at a side wall of the transport container.

It is advantageous if connecting portions or bearing portions of the carrying handle, whereby the carrying handle is connected to a side wall or cover of the transport container, are located in edge regions of the side wall or the cover. As a result the connecting portions or bearing portions can have large mutual distances. At the connecting portions or bearing portions, inner surfaces, forming or having form-fitting contours, of the through-opening of the guide rail are supported in a form-fitting manner, for example. The guide rail is for example supported on mutually spaced mating form-fitting contours of the carrying device, which are provided at the connecting portions or bearing portions of the carrying handle or represented by the connecting portions or bearing portions. In this way the guide rail can be held on the carrying device in a stable manner.

One option for connecting the guide rail to the carrying device provides that the mating form-fitting contours of the carrying device comprises at least one hook for hooking to a hook contour of the guide rail.

It is particularly advantageous if the carrying device has two or more hook contours at a mutual longitudinal distance so that the guide rail can be brought into engagement with a is hook contour of the carrying device each in two positions spaced from each other with respect to their longitudinal axis.

It can for example be provided that the at least one hook is located on the carrying body at a distance from the carrying handle. Consequently a carrying handle is available on the one hand and the at least one hook on the other hand.

One advantageous measure furthermore provides that the at least one hook is located at a side wall of an or of the transport container of the carrying device. Two or further hooks can obviously be located at the side wall, in particular at a distance parallel to the top side of the transport container.

The at least one hook can be located in a fixed manner at the carrying device, for example the transport container. It is also possible, however, that the at least one hook can be retrofitted to the carrying device as it were.

It is advantageously provided that the hook is located at a hook element which can be releasably connected to the carrying device, in particular to the transport container.

For the releasable fastening of the hook element, the following measure is particularly suitable, in which it is provided that the carrying device, in particular the transport container, has a plug-in holder for inserting the hook element. The hook element can for example have a plate body which can be fixed to the transport container or to the carrying device in the manner of a card.

One advantageous concept provides that the carrying device has a latch for locking the hook element in the plug-in holder, the latch being preferably represented by a cover of the or of a transport container of the carrying device. If the hook element is now accommodated in the plug-in holder, the hook element can be locked or fixed in the plug-in holder by closing the cover of the transport container.

It is possible that the at least one hook of the carrying device and the hook contour of the guide rail can be brought into mutual engagement or out of engagement by a pivoting action or exclusively by a sliding action, in particular parallel to the longitudinal axis of the guide rail. If two or further hooks are provided at the carrying device, for example, the hook contours of the guide rail can be capable of engagement with the hooks of the carrying device by a sliding action of the guide rail. In this way a better hold of the guide rail on the carrying device, in particular the transport container, can be achievable.

Exemplary embodiments of the invention are explained below with reference to the drawing, of which:

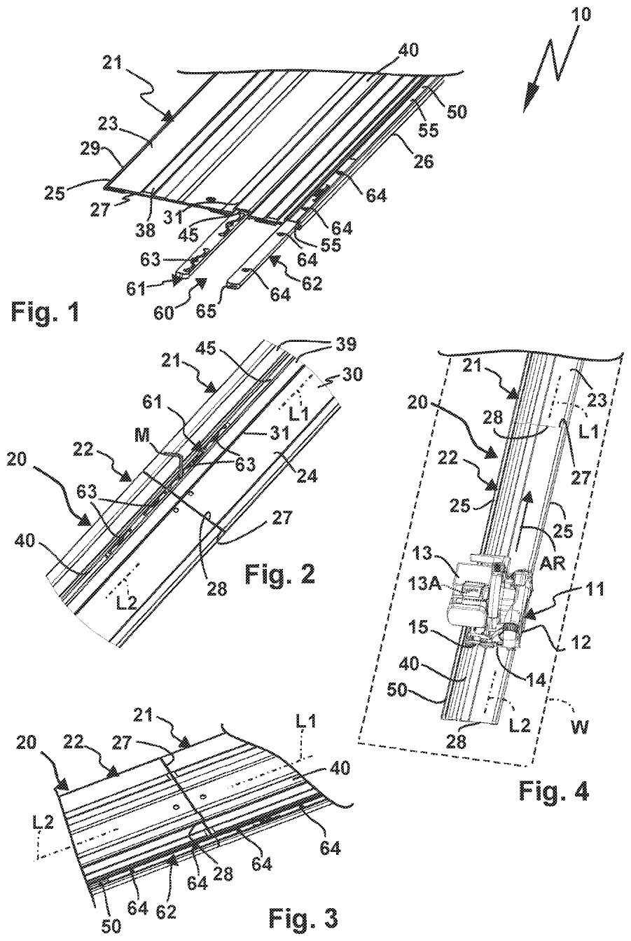

FIG. 1 shows a perspective oblique view from above of a longitudinal end of a guide rail with a connector arrangement,

FIG. 2 shows the longitudinal end of the guide rail according to FIG. 1 in a perspective view at an angle from above, the guide rail being connected to a further guide rail by means of the connector arrangement,

FIG. 3 shows the arrangement according to FIG. 2, but at an angle from below,

FIG. 4 shows the connected guide rails according to FIGS. 1 to 3 with a hand-held power tool guided thereon,

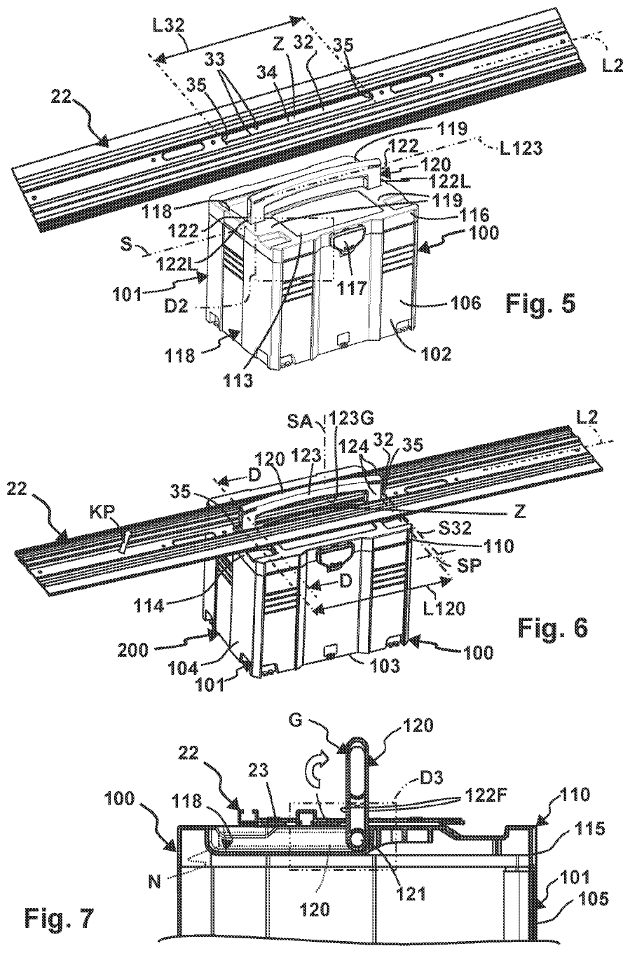

FIG. 5 shows a carrying device in the form of a transport container and a guide rail in a not yet connected state in a perspective oblique view,

FIG. 6 shows the view according to FIG. 5, the guide rail being located on the transport container,

FIG. 7 shows a sectional view of an upper part of the transport container and the guide rail, approximately along a line D-D of FIG. 6,

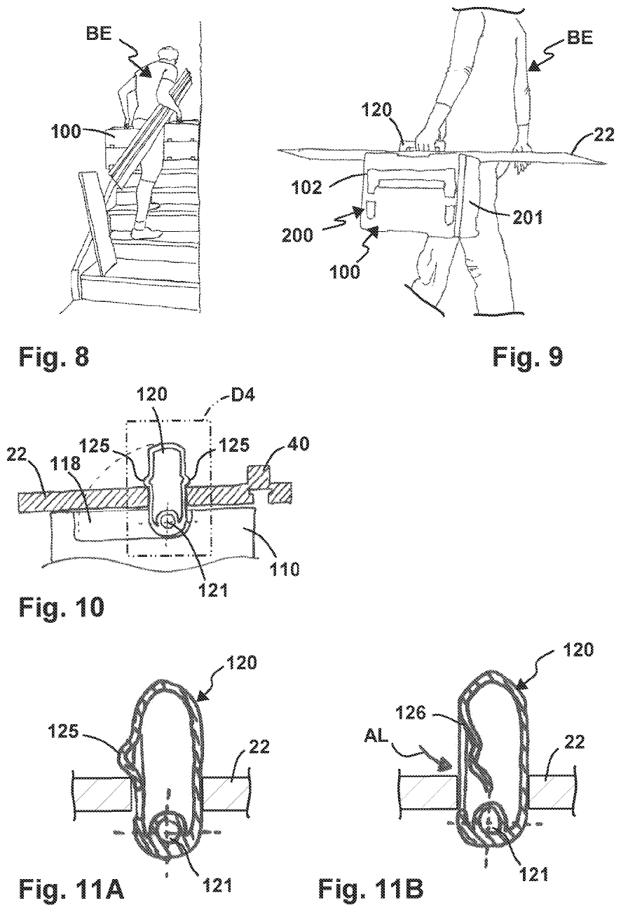

FIG. 8 shows a person carrying a guide rail without a carrying device,

FIG. 9 shows the person according to FIG. 8, wherein the person however carries the guide rail with the carrying device according to FIGS. 15 and 16,

FIG. 10 shows a variant of a carrying handle with a latching contour in a view approximately corresponding to a detail D3 in FIG. 7,

FIG. 11A shows the detail D4 from FIG. 10, the latching contour being in latching position,

FIG. 11B shows the view according to FIG. 11A, but with the latching contour in a release position,

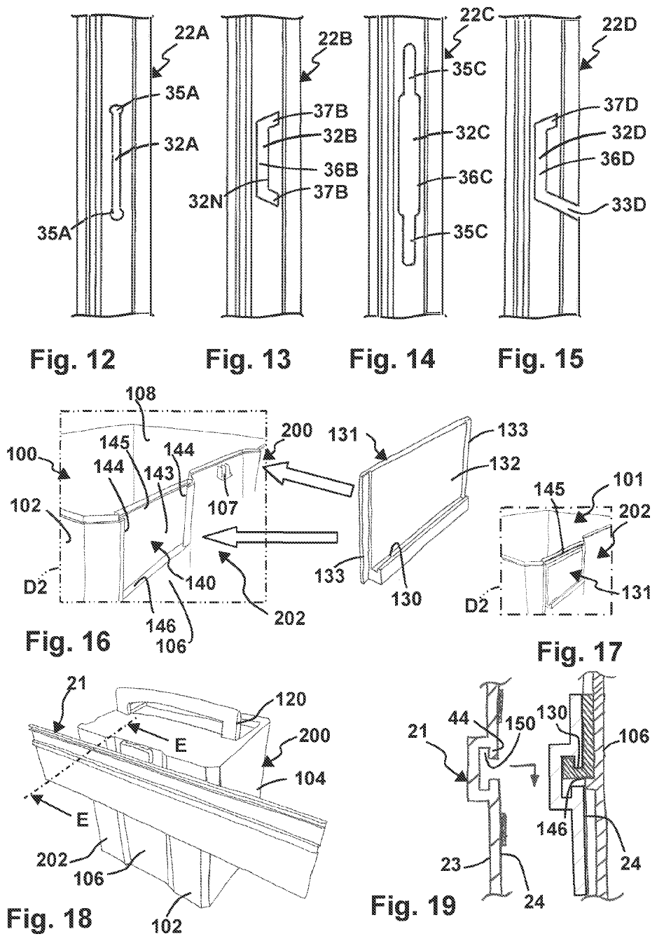

FIG. 12 shows a view from above of a central portion of a first variant of a guide rail according to FIG. 5,

FIG. 13 shows a view from above of a central portion of a second variant of a guide rail according to FIG. 5,

FIG. 14 shows a view from above of a central portion of a third variant of a guide rail,

FIG. 15 shows a view from above of a central portion of a fourth variant of a guide rail according to FIG. 5,

FIG. 16 shows an upper part of a transport container with a hook element not yet mounted thereon,

FIG. 17 shows a detailed view of the transport container according to FIG. 16 with mounted hook element,

FIG. 18 shows the transport container according to FIGS. 16, 17 with a guide rail held at the hook elements of the transport container,

FIG. 19 shows a partial section through the arrangement according to FIG. 18, approximately along a line D-D, wherein the guide rail is still removed from the transport container in the left part of the illustration and attached to the transport container in the right part of the illustration.

The guide rail assembly 20 is used to guide a hand-held power tool 11 at a workpiece not shown in the drawing. The hand-held power tool 11 is a sawing machine, for example, but can easily be a milling machine or a similar machine suitable for machining a workpiece as well. A drilling machine, in particular a drilling machine for drilling holes in a row adjacent to one another, can also be used optimally by means of the guide rail assembly 20. The hand-held power tool 11 in any case has a tool 12, for example a saw blade, which is held at a tool holder which can be driven by a drive motor 13A, in particular an electric drive motor. The drive motor 13A is accommodated in a housing 13 of the hand-held power tool 11, for example.

The hand-held power tool 11 furthermore has a guide plate 14, which could be described as a guide device in more general terms and which is suitable for guiding the hand-held power tool 11 on a ground and preferably for guiding the guide rail assembly 20 as well.

The guide rail assembly 20 has a first guide rail 21 and a second guide rail 22, with further guide rails readily possible as well. The two guide rails 21 and 22 and any further guide rails, if provided, can easily be lined up and firmly connected to one another by means of the connector arrangement 60 to be described in detail, thus forming a continuous long overall guide rail which can be used with the hand-held power tool 11 in one go, as it were.

On the guide rails 21, 22 there is located a guide projection 40, which can be brought into engagement with a guide receptacle 15 of the guide plate 14 in order to guide the hand-held power tool 11 for making a straight saw cut into a workpiece W. The hand-held power tool 11 can be guided along the guide rails 21, 22 or the guide rail assembly 20 along a working direction AR.

The guide projections 40 of the guide rails 21 and 22 are in alignment when connected to each other by the connector arrangement 60.

The guide rails 21 and 22 have substantially identical or similar components, which are explained below and provided with the same reference numbers.

The guide rails 21, 22 can be placed on a ground, for example the workpiece W, with their undersides or contact faces 24 and have a guide face 23 provided for guiding the hand-held power tool 11 on the side or top side opposite the contact face 24. The guide projection 40 protrudes in front of the guide face 23 for engagement with the guide receptacle 15 of the hand-held power tool 11.

The guide rails 21, 22 have an elongate shape and extend along longitudinal axes L1 and L2. The longitudinal axes L1 and L2 are in alignment with each other when the guide rails 21 and 22 are connected to each other by means of the connector arrangement 60. Also in alignment with the longitudinal axes L1 and L2 are parallel longitudinal sides 25 of the guide rails 21 and 22, past which the tool 12 or saw blade is guided when the hand-held power tool 11 is guided along the guide rail assembly 20. Even if it does not matter, longitudinal sides 24 of the guide rails 21 and 22 opposite the longitudinal sides 25 are in alignment when the guide rails 21 and 22 are connected to each other by means of the connector arrangement 60.

The guide rails 21 and 22 have end faces 27 and 28 transverse to the longitudinal axes L1 and L2, the end face 27 forming an end face in the front in the working direction AR and the end face 28 forming an end face at the rear in the working direction AR.

A guide rail 21 in the front in the working direction AR can be connected by its rear end face 28 to the end face 27 of a guide rail 22 at the rear in the working direction by means of the connector arrangement 60.

On the longitudinal side 25 of a respective guide rail 21, 22, a lip 29 is located, which serves as a tear-out protection and is cut to a suitable size by the tool 12 at the first use of the guide rail 21 or 22.

The guide rails 21, 22 have rail bodies 30, which are designed as extruded profiles, for example.

On the underside or contact face 24 of the guide rail 21, 22, one or more contact strips 39 can be provided. On the top side or guide face 23 of the guide rail 21, 22, sliding strips 38 can be provided, along which the hand-held power tool 11 can slide.

At the guide projection 40, the longitudinal guide face 31 is provided for the longitudinal guidance of the hand-held power tool 11 along the longitudinal axes L1 and L2 in the working direction AR.

The guide projection 40 is designed in the manner of a rib. Parallel to the guide projection there extends an auxiliaries receptacle 50 designed as a groove. Auxiliaries suitable for machining workpieces, components suitable for fastening the guide rail 21, 22 to a ground or the like can be accommodated in the auxiliaries receptacle 50.

The auxiliaries receptacle 50 and the guide projection 40 provide plug-in receptacles 55, 45 for connector elements 61, 62 of the connector arrangement 60, into which the connector elements 61, 62 can be inserted.

The connector element 61 and the associated plug-in receptacles 45 are provided for aligning the guide rails 21, 22 parallel to the guide face 23. The connector element 61 can also be described as a parallel connector element 61.

The connector element 62 forms a vertical connector element as it were. The connector element 62 is used to align the guide rails 21, 22 transversely to the guide faces 23.

For connecting the guide rails 21 and 22, plug-in portions 65 of the connector elements 61, 62 are inserted into opposite plug-in receptacles 45 and 46 of the guide rails 21, 22.

At the connector element 61, namely its plug-in portions 65, parallel clamping devices 63 are provided for clamping in the guide rails 21 and 22 to be connected to each other in the plug-in receptacles 45 with a clamping force parallel to the guide face.

At the connector element 62 vertical clamping devices 64 are located with which the connector element 62 can be clamped in the plug-in receptacles 55, in particular with a vertical clamping force acting at an angle, in particular a right angle, to the parallel clamping force.

The parallel clamping devices 63 and the vertical clamping devices 64 can be operated by means of an assembly tool M, with which operating bodies or clamping bodies, e.g. screws, of the clamping devices 63, 64 can be operated.

We can now imagine that the transport of the elongate and accordingly unwieldy guide rails 21 and 22 is inconvenient for all practical purposes. This is made for example clear in the illustration according to FIG. 8, which shows an operator BE climbing a staircase, the operator BE holding the guide rail 21 under his one arm and carrying a transport container 100 with the other arm.

Much more convenient for the operator BE is the situation with the arrangement according to FIG. 9, in which the guide rail 22 rests on the transport container 100, as it were, which the operator can grasp at a handle 101 of the transport container 100. The operator thus basically carries the transport container 100, on which the guide rail 22 is fastened.

The transport container 100 for example comprises a carcass 102 with a base 103 and side walls 104, 105 and 106 projecting from the base 103. The side walls 105 and 106 extend between the side walls 104 and together therewith bound a location space 108, in which the hand-held power tool 11 can be accommodated, for example.

The location space 108 can be closed by a cover 110. The cover 110 is pivotably mounted at the carcass 102, FIG. 16 showing an open position of the carcass 102. The cover 110 has a cover wall 113 and side walls 114, between which side walls 115 and 116 extend. The side walls 104 and 114 and side walls 105 and 115 and the side walls 106 and 116 are in alignment with one another when the cover 110 closes the carcass 111.

Swivel bearings not visible in the drawing are arranged between the side walls 105 and 115. The cover 110 is therefore pivotably mounted on the side wall 105.

At the side wall 116 a latch 117 is located, which can be brought into engagement with a latching contour 107 at the side wall 106 in order to close the transport container 100 reliably. The cover 110 is then firmly joined to the carcass 102.

A carrying handle 120 is located on the cover wall 113.

The cover wall 113 has swivel bearings 121, by means of which the carrying handle 120 is mounted for pivoting about a pivot axis S between an inoperative position N pivoted towards the cover wall 113 and an operative position G pivoted away from the cover wall 113. In the operative position G the carrying handle 120 protrudes from the cover wall 113 and can be grasped comfortably by an operator.

The cover wall 113 has an indentation 118 for the accommodation of the carrying handle 120 in the inoperative position N.

The carrying handle 120 has bearing portions 122 at its longitudinal ends and thus in the region of the swivel bearings 121. In the region and/or by means of the bearing portions 122, the carrying handle 120 is pivotably mounted on the transport container 100 and/or the cover wall 113.

Between the bearing portions 122 extends a handle portion 123, which can be grasped by the operator BE in the manner of a handhold.

The handle portion 123 preferably has an elongate shape and extends along a longitudinal axis L123.

The handle portion 123 and the bearing portions 122 extend at an angle to one another, for example approximately at a right angle.

The guide rail 22 has a through-opening 32 for the carrying handle 120. With its inner wall surfaces or insides 33, the through-opening 32 provides form-fitting contours 34, where the carrying handle 120 can be supported with the bearing portions 122.

Each bearing portion 122 has support contours 122F on mutually opposite sides. The support contours 122F are for example represented by flat wall portions or have flat wall portions. The support contours 122F are for example plane surfaces.

The bearing portions 122 form mating form-fitting contours 124 or have mating form-fitting contours 124. The mating form-fitting contours 124 can be brought into positive engagement with the form-fitting contours 34. The mating form-fitting contours 124 comprise the support contours 122F of the bearing portions 122, for example.

The carrying handle 120 is furthermore advantageously supported positively at longitudinal ends 35 of the through-opening 32, so that the guide rail 22 is advantageously supported by the carrying handle 120 so as to be non-displaceable with respect to its longitudinal axis L2. The longitudinal end regions or longitudinal ends 35 form form-fitting contours 34 as well.

The carrying handle 120, in particular the bearing portions 122, has/have support contours 122L on opposite or mutually averted sides with respect to the longitudinal axis L2, which support contours 122L likewise form parts of the mating form-fitting contours 124 and are provided for support at the longitudinal ends 35 of the through-opening 32.

When the guide rail 22 is inserted through the through-opening 32, there is a reach-through opening 123G between the handle portion 123 and the guide rail 22 held at the carrying handle 120. An operator BE can encompass the handle portion 123 with his/her hand while reaching through the reach-through opening 123G.

The contact face 24 or the guide face 23 can be supported on the cover wall 113 or on support faces 119 of the cover wall 113 when the carrying handle 120 is inserted through the through-opening 32.

In addition the carrying handle 120 is fixed by the form-fitting contours 32 in its operative position G and can therefore no longer pivot into the inoperative position N. Carrying comfort is optimal.

In the drawing it can be recognised that the through-opening 32 is located approximately in the longitudinal centre with respect to the longitudinal axis L2, so that the guide rail 22 protrudes substantially to the same extent in front of the side walls 104 of the transport container 100.

The through-opening 32 is furthermore provided at the guide rail 22 approximately in the transverse centre transversely to the longitudinal axis L2.

The two above-mentioned measures ensure that the through-opening 32 is located approximately in a centre Z of the guide rail 22, thus also in a centre Z of the contact face 24 or the guide face 23 of the guide rail 22. The carrying handle 120 is therefore also in the centre Z when the guide rail 22 is located on the transport container 100.

For a reliable mutual hold of the form-fitting contours 34, 124 or for securing the carrying handle 120 in the through-opening 32, a latching contour 125 is advantageously provided. The latching contour 125 is for example represented by a resilient portion 126 on one of the bearing portions 122. Latching contours 125 can also be provided on opposite sides of the carrying handle 120, for example, e.g. opposite sides of a bearing portion 122 (see FIG. 10). Each of the bearing portions 122 can have latching contours of the type of the latching contour 125.

In FIG. 11A the latching contour 125 protrudes on front of the contact face 24 or the guide face 23 of the guide rail 22, so that the guide rail 22 is held on the cover wall 113. To release it, the latching contour 125 is deflected into a release position, for example by an operation AL (FIG. 11B), i.e. brought out of engagement with the guide rail 22, so that the carrying handle 120 can once again be guided out of the through-opening 32.

The through-opening 32 is preferably designed as a longitudinal slot. A transverse width of the longitudinal slot or the through-opening 32 transverse to the longitudinal axis L2 is constant along the entire length parallel to the longitudinal axis L2. A length L32 of the through-opening 32 between its longitudinal ends 35 is preferably dimensioned such that it corresponds to an outer distance of the bearing portions 122, i.e. the carrying handle 120 is advantageously held non-displaceably with respect to the longitudinal axis L2 in the through-opening 32 when in engagement therewith.

It is possible that the length L32 of the through-opening 32 is dimensioned such that the carrying handle 120 can only be displaced or inserted with respect to the through-opening 32 transversely to the longitudinal axis L2 or transversely to the length L32, but cannot be pivoted apart from a play required for pushing the carrying handle through to the through-opening 32, for example a play SP with respect to the longitudinal axis L123 of the carrying handle 120 which is parallel to a longitudinal axis of the through-opening 32 or to the longitudinal axis L2, when the carrying handle 120 protrudes through the through-opening 32.

Another embodiment can provide that the guide rail 22 is pivotable with respect to the carrying handle 120 for bringing the through-opening 32 into or out of engagement with the carrying handle 120. The length L2 of the through-opening 32 is for example dimensioned such that the play SP forms a pivoting play or is long enough to facilitate a pivoting play. In this case the guide rail 22 can for example be pivoted about a longitudinal end of the carrying handle 120, e.g. about a pivot axis S32, in order to bring the through-opening 32 into and/or out of engagement with the carrying handle 120. Such a pivoting movement is indicated in the drawing by an arrow KP.

Alternative through-openings are illustrated in FIGS. 12 to 15.

In longitudinal end regions of a through-opening 32A of a guide rail 22A, widened portions 35A are provided, for example, to facilitate an insertion of the carrying handle 120. The guide rail 22A otherwise substantially corresponds to the guide rail 22.

The guide rails 22B, 22C and 22D described in the following also largely correspond to the guide rail 22, but have through-openings 32B, 32C and 32D as alternatives to the through-opening 32.

The through-opening 32B has a central portion 36B, which is assigned to the handle portion 123 and from which extend portions 37B assigned to the bearing portions 122. The through-opening 32B facilitates the movement of the carrying handle 120 into the inoperative position N.

A contour of the through-opening 32B therefore corresponds to a lateral contour of the carrying handle 120, so that it can be moved from the operative position G into the through-opening 32B into the inoperative position N. The through-opening 32B thus for example forms an inoperative position receptacle 32N for the carrying handle 120. In the inoperative position N the carrying handle 120 for example protrudes not at all or only a little in front of the guide face 23 or contact face 24—averted from the cover wall 113—of the guide rail 22. The carrying handle 120 can nevertheless be pivoted out of the through-opening 32B or the inoperative position 32N into the operative position G in order to be able to carry the assembly of transport container 100 and guide rail 22B comfortably.

In the configuration according to FIG. 14, the guide rail 22C has a through-opening 32C with a central portion 36C, through which the handle portion 123 can be inserted, and end portions 35C, which extend from the central portion 36C parallel to the longitudinal axis L2 and which are narrower than the central portion 36C and provided for the form-fitting hold of the bearing portions 122 of the carrying handle 120. Through the wider central portion 36C, the operator can grasp the handle portion 123 of the carrying handle 120 better. The central portion 36C therefore forms a kind of grip recess.

In the configuration according to FIG. 15, the guide rail 22D has a through-opening 32D having a lateral insertion opening 33C, a central portion 36D and an end portion 37D. The carrying handle 120 can be guided through the insertion opening 33D, threaded into the through-opening 32D in a manner of speaking, in order to establish in this way a form-fitting connection between the carrying handle 120 or the transport container 100 and the guide rail 22.

The transport container 100 thus forms a carrying device 200, the cover 110 and the cover wall 113 in particular forming a carrying body 201, from which a carrying handle 120 extends.

The front side wall 106 can also form a carrying body, however, for example the carrying body 202. Hooks 130 can be provided at the side wall 106.

The hooks 130 can for example be provided on hook elements 131, which are or can be accommodated in plug-in holders 140 at the transport container 100. The hook elements 131 for example comprise plate bodies 132 having plug-in projections 133 on opposite longitudinal sides. The plug-in projections 133 can be inserted into grooves 144 of the plug-in holders 140, the grooves 144 lying opposite one another. A flat side of the plate body 132 is in contact with a base 143 of the plug-in holder 140. The plug-in holders 140 have plug-in openings 145, through which the hook elements 131 can be inserted.

Opposite the plug-in openings 145, a support contour 146 is provided for supporting a respective hook element 131 when inserted into the plug-in holder 140. The support contour 146 and the grooves 144 extend at an angle to one another.

When the cover 110 is closed, it holds the hook elements 131 in the plug-in holders 140. The hook elements 131 are for example supported on the end face of the side wall 116 of the cover 110. The cover 110 thus forms a latch for locking a respective hook element 131 in a plug-in holder 140.

A respective hook 130 protrudes in front of the plate body 132 and is designed in the manner of a receptacle groove, for example. The hook 130 can engage with a hook contour 150 of a guide rail 21 or 22. Such a hook contour 150 is for example provided by one of the limbs 54 or 44. With the limbs 54 or 44, the guide rail 21 or 22 can be hooked into the hooks 130, wherein the contact face 24 can then be supported in a planar fashion on the front side or side wall 106 of the transport container 100, for example. The guide rail 21 or 22 therefore hangs at the front of the transport container 100, as it were, so that it can be transported comfortably.

1. A system comprising at least one guide rail, which is provided for guiding a hand-held power tool, has an elongate shape and extends along a longitudinal axis, wherein the guide rail has, on mutually opposite sides, a contact face for the guide rail to rest on a workpiece and a guide face in front of which a longitudinal guide face extending along the respective longitudinal axis for guiding the hand-held power tool protrudes parallel to the longitudinal axis, and wherein the system comprises a carrying device having a carrying body and a carrying handle located on the carrying body to be grasped by an operator, wherein the guide rail, for a connection to the carrying device, has form-fitting contours which can be brought into engagement with mating form-fitting contours of the carrying device, so that the guide rail can be carried by an operator using the carrying handle.

2. The system according to claim 1, wherein the carrying device has a support face for the planar support of the guide rail.

3. The system according to claim 1, wherein the guide rail has a through-opening for the carrying handle, which through-opening extends between two mutually opposite sides, and through which through-opening the carrying handle can be inserted.

4-7. (canceled)

8. The system according to claim 1, wherein the carrying handle protrudes in front of the guide face or the contact face, when the carrying device is connected to the guide rail.

9. The system according to claim 1, wherein the carrying handle is mounted at the carrying body for pivoting between an operative position, in which the carrying handle protrudes in front of the carrying body, and an inoperative position, in which the carrying handle is moved closer towards the carrying body than in the operative position.

10. The system according to claim 1, wherein the carrying handle is fixed by the guide rail in the operative position when the guide rail and the carrying device are connected to each other.

11-13. (canceled)

14. The system according to claim 1, wherein the carrying handle protrudes in front of the contact face or the guide face approximately at right angles when the guide rail is connected to the carrying device.

15. (canceled)

16. The system according to claim 3, wherein there is a reach-through opening provided and designed for grasping the handle portion with a hand of an operator between a handle portion of the carrying handle and the guide rail when the carrying handle is inserted through the through-opening and/or the guide rail is connected to the carrying device.

17. The system according to claim 3, wherein the carrying handle is exclusively insertable through the through-opening along an insertion axis extending at an angle, to the longitudinal axis of the guide rail.

18. The system according to claim 3, wherein the through-opening has an elongate shape and a length of the through-opening between its longitudinal ends is dimensioned such that the carrying handle is pivotable about a pivot axis extending at an angle to the longitudinal axis in order to bring the carrying handle into or out of engagement with the through-opening.

19. The system according to claim 1, wherein the carrying device and the guide rail can be connected to each other by means of the form-fitting contours and the mating form-fitting contours in such a way that the carrying handle cannot be pivoted and/or displaced with respect to the guide face when the carrying device and the guide rail are connected to each other.

20-21. (canceled)

22. The system according to claim 1, wherein the carrying body comprises a transport container with a location space for objects, or is represented by a transport container, the carrying handle being provided and designed for carrying the transport container.

23. The system according to claim 22, wherein the carrying handle is located on a top side, of the transport container.

24. (canceled)

25. The system according to claim 1, wherein the mating form-fitting contour of the carrying device comprises at least one hook for hooking to a hook contour of the guide rail.

26. The system according to claim 25, wherein the at least one hook is located at a distance from the carrying handle and/or at a side wall of the transport container of the carrying device.

27-30. (canceled)

31. The system according to claim 25, wherein the at least one hook of the carrying device and the hook contour of the guide rail can be brought into mutual engagement or out of engagement by a pivoting action.

32. A carrying device for carrying a guide rail provided for guiding a hand-held power tool, wherein the carrying device has a carrying body and a carrying handle for grasping by an operator, having mating form-fitting contours for engagement with form-fitting contours of the guide rail, so that the guide rail can be carried by an operator using the carrying handle.

33. The carrying device according to claim 32, wherein the mating form-fitting contours are located at the carrying handle or represented by the carrying handle.

34. A guide rail, wherein the guide rail has an elongate shape and extends along a longitudinal axis, wherein the guide rail has on mutually opposite sides a contact face for the guide rail to rest on a workpiece and a guide face in front of which a longitudinal guide face extending along the respective longitudinal axis for guiding the hand-held power tool protrudes parallel to the longitudinal axis, wherein the guide rail, for a connection to the carrying device, has form-fitting contours which can be brought into engagement with mating form-fitting contours of the carrying device, wherein the carrying device has a carrying body and a carrying handle located on the carrying body to be grasped by an operator, so that the guide rail can be carried by an operator using the carrying handle.

35. The guide rail according to claim 34, further comprising a through-opening for inserting the carrying handle.
